(19) United States
(12) Patent Application Publication
(10) Pub. No.: US 2015/0240586 A1
(43) Pub. Date: Aug. 27, 2015

(54) Well Tools Having Energized Seals

(71) Applicant: Halliburton Energy Services, Inc., Houston, TX (US)

(72) Inventor: Kristopher V. Sherrill, Thousand Oaks, CA (US)

(73) Assignee: Halliburton Energy Services, Inc., Houston, TX (US)

(21) Appl. No.: 14/423,676

(22) PCT Filed: Oct. 1, 2012
(86) PCT No.: PCT/US2012/058336

§ 371 Date: Feb. 24, 2015

(51) Int. Cl. E21B 33/12; E21B 12/00; F16J 15/18

(52) U.S. Cl. CPC E21B 33/12; F16J 15/186; E21B 12/00

(57) ABSTRACT

A sealing system can include an annular seal comprising a resilient material, and a spring which applies a compressive force to the seal as a resilience of the material diminishes, the spring being external to the seal. A sealing method can include installing a seal in a well tool, the seal being compressed radially as a result of the installing, and a spring external to the seal exerting a compressive force on the seal. A well tool can include a seal radially compressed between seal surfaces of the well tool, due to the seal having a greater radial dimension as compared to a radial distance between the seal surfaces, and a spring which exerts a compressive force on the seal, the spring being external to the seal.

### TECHNICAL FIELD

This disclosure relates generally to sealing systems for sealing against fluid pressure and, in one example described below, more particularly provides a well tool having an energized seal.

### BACKGROUND

Seals in well tools typically must withstand relatively large differential pressures at relatively high temperatures. Even if a differential pressure against which a particular seal seals would not be considered a “high” differential pressure, if the seal has been exposed to relatively high temperatures, the seal can take a “set” (e.g., become deformed and lose its resilience), and become unable to seal against relatively low differential pressures.

It will, therefore, be readily appreciated that improvements are continually needed in the art of constructing seals.

### BRIEF DESCRIPTION OF THE DRAWINGS

FIG. 1 is a representative partially cross-sectional view of a system and associated method which can embody principles of this disclosure.

FIG. 2 is a representative cross-sectional view of a well tool which may be used in the system and method of FIG. 1, and which can embody principles of this disclosure.

FIG. 3 is a representative cross-sectional view of a sealing system which may be used in the well tool of FIG. 2, and which can embody principles of this disclosure.

### DETAILED DESCRIPTION

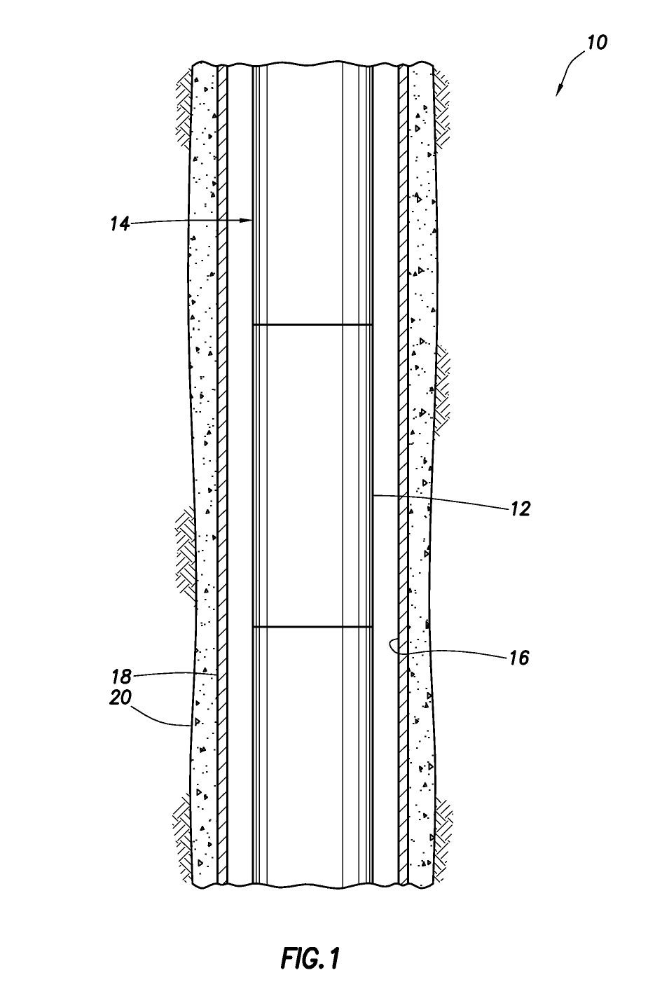

Representatively illustrated in FIG. 1 is a system 10 and associated method which can embody principles of this disclosure. However, it should be clearly understood that the system 10 and method are merely one example of an application of the principles of this disclosure in practice, and a wide variety of other examples are possible. Therefore, the scope of this disclosure is not limited at all to the details of the system 10 and method described herein and/or depicted in the drawings.

In the FIG. 1 example, a well tool 12 is connected in a tubular string 14 installed in a wellbore 16. The well tool 12 may be any type of well tool, for example, a packer, a production or stimulation valve, a choke, a pump, etc. In other examples, the well tool 12 could be a drilling tool, wireline tool, stimulation tool, gravel packing tool, or any other type of well tool. The scope of this disclosure is not limited to use with any particular type of well tool.

The wellbore 16 is lined with casing 18 and cement 20. In other examples, the wellbore 16 may be uncased or open hole, and/or inclined or deviated. The scope of this disclosure is not limited to use in any particular type of wellbore.

In other examples, the well tool 12 is not necessarily connected in a tubular string. Thus, it should be clearly understood that the scope of this disclosure is not limited to any of the details of the system 10 and method depicted in the drawings or described herein.

The well tool 12 includes one or more seals which preferably continue to seal after they have been exposed to relatively high downhole temperatures (e.g., over 300 deg. F, 149 deg. C). The seals can continue to seal, even after they have taken a “set” due to the elevated downhole temperatures.

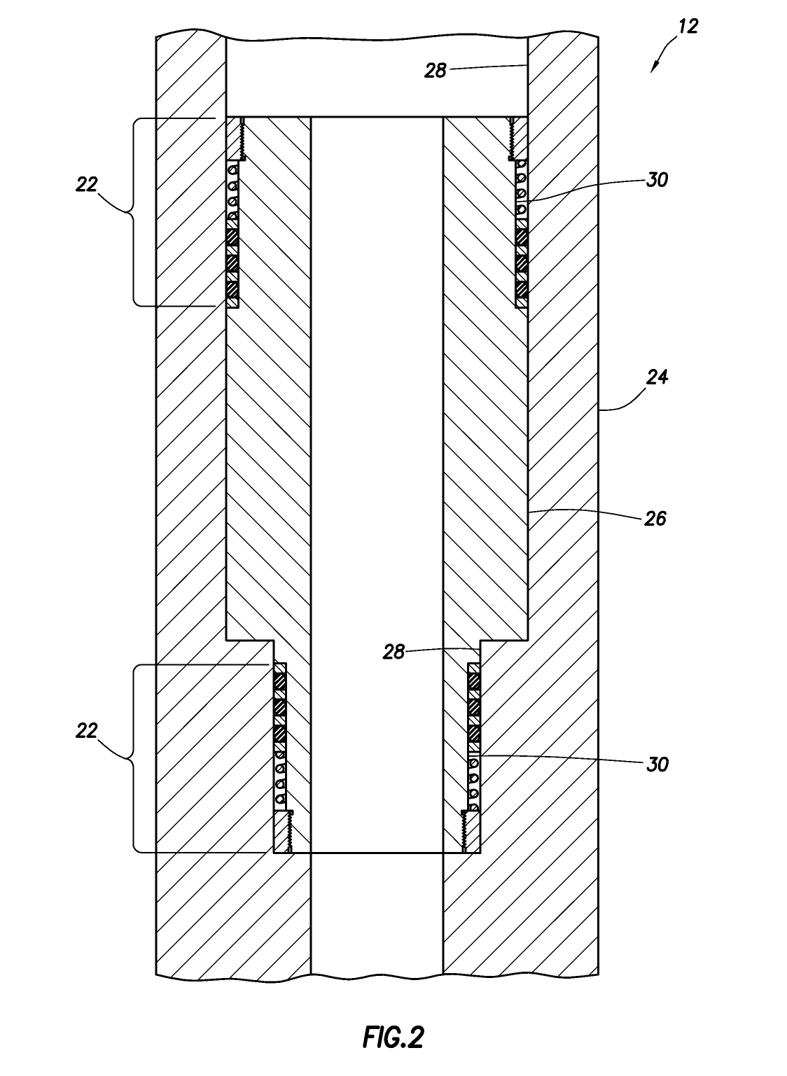

Referring additionally now to FIG. 2, an enlarged scale cross-sectional view of a portion of the well tool 12 is representatively illustrated. In this view, it may be seen that two sealing systems 22 are used to seal off an annular space between an outer housing 24 and an inner mandrel 26.

In this example, the sealing systems 22 are installed externally on the mandrel 26 and are received in seal bores or surfaces 28 in the outer housing 24. However, in other examples, the sealing systems 22 could be carried internally in the outer housing 24 for engagement with external seal surfaces 30 on the mandrel 26. Thus, the scope of this disclosure is not limited to any particular details of the well tool 12 described herein and/or depicted in the drawings.

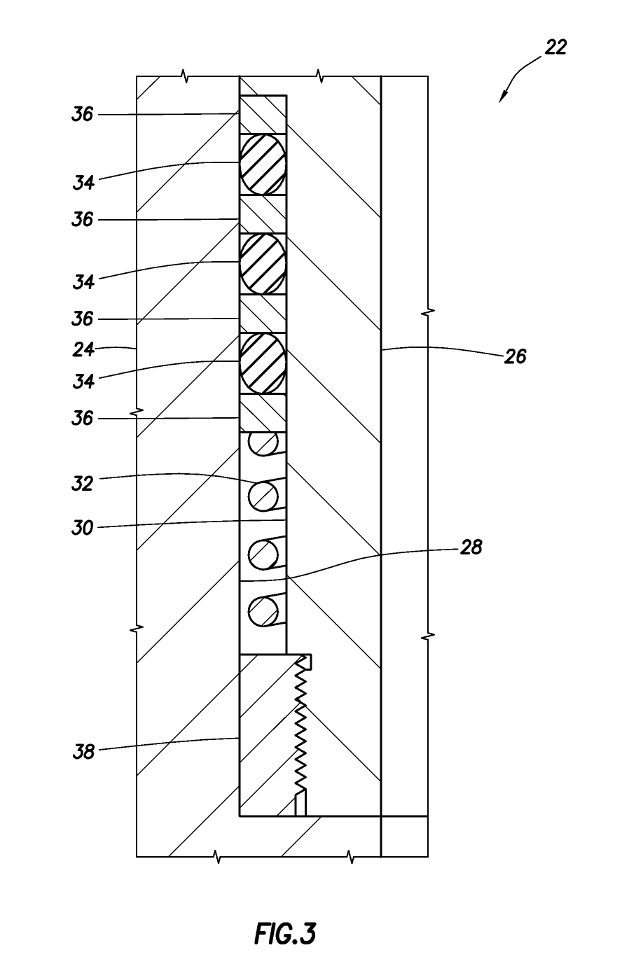

Referring additionally now to FIG. 3, an enlarged scale cross-sectional view of one of the sealing systems 22 is representatively illustrated. In this view, it may be seen that the sealing system 22 includes a spring 32 which applies a longitudinally compressive force to multiple annular seals 34 radially compressed between the seal surfaces 28, 30.

Anti-extrusion backup rings 36 are used to prevent extrusion of the seals 34 due to a pressure differential across the seals. Note that any number of springs 32, seals 34 and anti-extrusion rings 36 may be used, as desired.

A threaded ring 38 is threaded onto the mandrel 26, in order to longitudinally compress the spring 32. The compressive force applied longitudinally to the seals 34 by the spring 32 may be increased before or after the seals are installed between the mandrel 26 and the outer housing 24.

In one installation method, the seals 34, anti-extrusion rings 36 and spring 32 can be positioned on the mandrel 26, and then the threaded ring 38 can be threaded onto the mandrel to compress the spring longitudinally between the threaded ring and an end one of the anti-extrusion rings. The sealing system 22 is then installed in the outer housing 24, so that the seals 34 sealingly engage the seal surface 28.

Alternatively, the seals 34, anti-extrusion rings 36 and spring 32 can be positioned on the mandrel 26, and then the mandrel (with the seals and anti-extrusion rings thereon) can be installed in the outer housing 24, so that the seals sealingly engage the seal surface 28. Then, the threaded ring 38 can be threaded onto the mandrel 26 to compress the spring 32 longitudinally between the threaded ring and an end one of the anti-extrusion rings 36.

Preferably, the seals 34 (when initially installed) are dimensioned so that they are radially compressed between the seal surfaces 28, 30 whether or not the spring 32 exerts a longitudinal compressive force on the seals. For example, the seals 34 could have a radial thickness which is greater than a radial separation between the seal surfaces 28, 30. Thus, the seals 34 can seal against the surfaces 28, 30, even if the spring 32 does not longitudinally compress the seals.

If the seals 34 lose their resiliency, however, (for example, due to exposure to elevated temperatures in a well) they can become “set” in a deformed configuration in which their relaxed radial thickness is not greater than the radial distance between the sealing surfaces 28, 30. In that case, the longitudinal compression of the seals 34 by the spring 32 will act to radially extend the seals into sealing engagement with the surfaces 28, 30.

In one example, the seals 34 could be made of a resilient elastomeric material (such as, nitrile, fluoro-elastomer, EPDM, etc.). Unfortunately, the resilience of such materials can be reduced due to exposure to elevated temperatures. The system 22 in effect compensates for this reduced resilience by longitudinally compressing the seals 34, so that they will extend radially inward and outward into sealing contact with the surfaces 28, 30.

Although the spring 32 is depicted in the drawings as being a single coiled spring, in other examples the spring could be replaced by wave springs, Belleville washers, or any other type of biasing device. The scope of this disclosure is not limited to use of any particular type of spring.

A sealing method is provided to the art by the above disclosure. In one example, the method can include installing at least one seal 34 in a well tool 12, the seal 34 being compressed radially as a result of the installing;

and at least one spring 32 external to the seal 34 exerting a compressive force on the seal 34.

The seal 34 may comprise a resilient material. The spring 32 may exert the compressive force on the seal 34 after a resilience of the material diminishes.

The compressive force can be applied longitudinally to the seal 34 by the spring 32.

The seal 34 may comprise an elastomeric material.

The method can include compressing the spring 32 prior to positioning the well tool 12 in a well.

The installing step can include positioning an anti-extrusion ring 36 between the seal 34 and the spring 32.

The spring 32 may comprise a coiled spring.

A well tool 12 is also described above. In one example, the well tool 12 can comprise at least one seal 34 radially compressed between seal surfaces 28, 30 of the well tool 12, due to the seal 34 having a greater radial dimension as compared to a radial distance between the seal surfaces 28, 30; and at least one spring 32 which exerts a compressive force on the seal 34, the spring 32 being external to the seal 34.

Also provided to the art is a sealing system 22. In one example described above, the system 22 can include at least one annular seal 34 comprising a resilient material, and at lest one spring 32 which applies a compressive force to the seal 34 as a resilience of the material diminishes, the spring 32 being external to the seal 34.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A sealing method, comprising:
installing at least one seal in a well tool, the seal being compressed radially as a result of the installing; and
at least one spring external to the seal exerting a compressive force on the seal.

2. The method of claim 1, wherein the seal comprises a resilient material, and wherein the spring exerts the compressive force on the seal after a resilience of the material diminishes.

3. The method of claim 1, wherein the compressive force is applied longitudinally to the seal by the spring.

4. The method of claim 1, wherein the seal comprises an elastomeric material.

5. The method of claim 1, further comprising compressing the spring prior to positioning the well tool in a well.

6. The method of claim 1, wherein the installing further comprises positioning an anti-extrusion ring between the seal and the spring.

7. The method of claim 1, wherein the spring comprises a coiled spring.

8. A well tool, comprising:
at least one seal radially compressed between seal surfaces of the well tool, due to the seal having a greater radial dimension as compared to a radial distance between the seal surfaces; and
at least one spring which exerts a compressive force on the seal, the spring being external to the seal.

9. The well tool of claim 8, wherein the seal comprises a resilient material, and wherein the spring exerts the compressive force on the seal after a resilience of the material diminishes.

10. The well tool of claim 8, wherein the compressive force is applied longitudinally to the seal by the spring.

11. The well tool of claim 8, wherein the seal comprises an elastomeric material.

12. The well tool of claim 8, wherein the spring is compressed prior to the well tool being positioned in a well.

13. The well tool of claim 8, further comprising an anti-extrusion ring between the seal and the spring.

14. The well tool of claim 8, wherein the spring comprises a coiled spring.

15. A sealing system, comprising:
at least one annular seal comprising a resilient material; and
at least one spring which applies a compressive force to the seal as a resilience of the material diminishes, the spring being external to the seal.

16. The sealing system of claim 15, wherein the seal is radially compressed between seal surfaces of a well tool, due to the seal having a greater radial dimension as compared to a radial distance between the seal surfaces.

17. The sealing system of claim 15, wherein the compressive force is applied longitudinally to the seal by the spring.

18. The sealing system of claim 15, wherein the resilient material comprises an elastomeric material.

19. The sealing system of claim 15, wherein the spring is compressed prior to the sealing system being positioned in a well.

20. The sealing system of claim 15, further comprising an anti-extrusion ring between the seal and the spring.

21. The sealing system of claim 15, wherein the spring comprises a coiled spring.
